(19) United States
(12) Patent Application Publication
(10) Pub. No.: US 2003/0207242 A1
(43) Pub. Date: Nov. 6, 2003

(54) Method for generating customizable comparative online testing reports and for monitoring the comparative performance of test takers

(76) Inventors: Ramakrishnan Balasubramanian, Chennai (IN); Ramesh Babu Kanda Swamy, Chennai (IN)

Correspondence Address: B. RAMAKRISHNAN, 24/16 DR. SUBBARAYA NAGAR, 4th STREET, KODAMBAKKAM, CHENNAI, TAMILANDU, 600024, IN

(21) Appl. No.: 10/138,251

(22) Filed: May 6, 2002

(51) Int. Cl. G09B 7/00

(52) U.S. Cl. 434/322

(57) ABSTRACT

A method for generating comparative online testing reports for a variety of competitive examinations is implemented. Questions are delivered to the user over a network and the responses are stored. The responses are collated and compared dynamically with the responses of other users who have taken the test. A variety of comparative reports are generated and displayed to the user.

### CROSS-REFERENCE TO RELATED APPLICATIONS

This application claims priority based on U.S. Provisional Patent Application No. 60/291,615, entitled “Machine and method for conducting customizable comparative online testing procedures (on Internet and other computing/processing/operating networks) and monitoring the performance of test takers from the resulting tested information for a variety of purposes.” filed May 18, 2001.

### REFERENCES CITED

U.S. Patent documents

| | | |
|---|---|---|
| 5218537 | June 1993 | Hemphill et al. |
| 5228859 | July 1993 | Rowe. |
| 5257185 | October 1993 | Farley et al. |
| 5267865 | December 1993 | Lee et al. |
| 5302132 | April 1994 | Corder. |
| 5306154 | April 1994 | Ujita et al. |
| 5310349 | May 1994 | Daniels et al. |
| 5316485 | May 1994 | Hirose. |
| 5421730 | June 1995 | Lasker, III et al. |
| 5618182 | April 1997 | Thomas; C. Douglass |
| 6,086,382 | July 2000 | Thomas; C. Douglass. |

### OTHER REFERENCES

1. The Integrated Instructional Systems Report; February 1990; EPIE Institute; Water Mill, N.Y.

2. 1992 Computerized Testing Products Catalog; Assessment Systems Corporation.

3. Anthony DePalma, “Standardized College Exam Is Customized by Computers”, The New York Times, Front Page Story Mar. 21, 1992.

4. ETS/Access Summer 1992 Special Edition Newsletter

5. Elliot Soloway, “Quick, Where Do the Computers Go; Computers In Education”, Communications of the ACM, Association for Computing, Machinery 1991, Feb. 1991, vol. 34, No. 2, p. 29.

6. Tse-chi Hsu and Shula F. Sadock, “Computer-Assisted Test Construction: A State the Art”, TME Report 88, Educational Testing Service, November 1985

7. Computer-based Testing (CBT) Program Supplement to the 1992-93 GRE Information Bulletin, Educational Testing Service, 1992, pp. 1 and 7-9.

8. Computer-based Testing (CBT) Program Supplement to the 1993-94 GRE formation and Registration Bulletin, Educational Testing Service, 1993, pp. 1, 9 and 11.

### REFERENCE TO SEQUENCE LISTING, A TABLE, OR A COMPUTER PROGRAM LISTING COMPACT DISK APPENDIX

Not Applicable

### STATEMENT REGARDING FEDERALLY SPONSORED RESEARCH OR DEVELOPMENT

Not Applicable

### BACKGROUND OF THE INVENTION

1. Field of the Invention

This invention relates generally to the field of inventions, and more particularly to a method of conducting Online-tests and a method of generating reports based on the tests.

2. Description of the Related Art

An important use of computers and devices and network of such devices in any form is the storage and processing of information. Currently, the largest computer network in existence is the Internet, which is a worldwide network of millions of computers, from low-end personal computers to high-end mainframes. The current invention can ideally be deployed on, though not limited to, the Internet.

Testing procedures have been usually administered either orally or in a written fashion or recorded using devices like computers. Each testing procedure is usually administered with limited relation to performance in earlier tests. An exciting use of the Internet is the ability to administer a variety of tests over the Internet to geographically dispersed persons and compare their results immediately. For example, this would allow a person from a small town take a test over the Internet and compare her/his performance with the performance of persons from Big cities who had taken the test. The comparison can be done also with specific groupings of persons by age or geography or IQ or sex or school or by any other classification criteria chosen.

These comparative tests will help the person rate himself with others, track his own performance across a number of tests that she or he takes over a period of time and the inventors believe these comparisons will aid in his/her focused and effective learning of a subject area. Without this invention, testing across a wide geographic area with immediate comparison of results and feedback to the test taker on where exactly he/she stands with respect to other test takers will be cumbersome.

Currently, testing is typically administered in a written manner in locations where the test takers have to physically assemble. On completion of the tests, the answer papers are sent to qualified experts who correct the answer sheets and submit it to the testing authority that then assimilates all the results and notifies the test persons of the results.

A second method is to provide the test in an Internet Website where the tested persons download the test paper, answer it and upload it back to the Website for correction, assimilation and notification of results.

A third method is to distribute the test questions on a storage device where the tested persons answer the test questions in a paper and send it back to the testing authority for correction, assimilation and notification of results.

A fourth method is conducting the test orally to a group of persons either individually or collectively.

Other testing mechanisms are quite similar to the four major methods mentioned above.

All these testing mechanisms suffer from one or several of the following problems

Testing is limited to areas where the test paper can be physically distributed

Testing has a requirement of papers to mark answers

A physical place is required for the testing to be conducted

Answer sheets have to collected and assimilated by the testing authority

Experts in the tested field have to be employed to correct the answer sheet after each testing activity

Since different experts would be employed to correct different persons answer sheets, there is likely to be an element of subjectivity

Results have to be, usually, individually communicated to all tested persons

There is a time lag between the testing activity and the announcement of the results

Extensive comparisons of results is not immediately available

A link between one test and another or between one test taker and another does not exist.

Our invention overcomes all these problems by providing dynamic and extensive comparative reports linking up all tests and all test takers together inside a single framework.

### BRIEF SUMMARY OF THE INVENTION

The aforementioned needs are addressed by the present invention. Accordingly there is provided, in a first form, a method of comparative online testing reports implementation. The method includes the step of delivery of questions to the user, storing responses of the user, and collating and comparing the stored responses of various users in a variety of ways to generate a variety of Comparative Online Testing reports.

There is also provided, in a second form a program product adaptable for storage on program storage media. The program product is operable for implementing comparative online testing report generation mechanism, which includes programming for delivery of questions to the user, and programming for storing user responses. Also included is programming for collating and comparing the stored responses of different users, the comparison and collation being done under various criteria

Additionally there is provided, in a third form, a data processing system for implementing Comparative Online Testing report generation mechanism. The data processing system includes circuitry operable for delivering questions to the user, and circuitry operable for storing the responses of various users, and circuitry operable for collating and comparing stored responses under various criteria, and circuitry operable for generating various varieties of Comparative Online Test Reports.

The primary object of the present invention is to provide a method for generating comparative online test reports through online testing procedures to continuously track the comparative performance of persons in a variety of subjects, that can also be customized as per the person's requirement, thereby helping the person/groups of persons know where exactly they stand with respect to other persons/group of persons.

Other objects and advantages of the present invention will become apparent from the following descriptions, taken in connection with the accompanying drawings, wherein, by way of illustration and example, an embodiment of the present invention is disclosed.

The drawings constitute a part of this specification and include exemplary embodiments to the invention, which may be embodied in various forms.

In the preferred embodiment, a machine and method for conducting Online Testing procedures to continuously track the comparative performance of persons in a variety of subjects, that can also be customized as per the person's requirement, comprises an input device such as a keyboard or mouse, an output device such as a display or printer, and a computing device for receiving data from the input devices and for transmitting data to the output devices. The computing device also stores program steps for program control and manipulates data in memory. This computing device is typically connected to an Internet/local server.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of an embodiment of an apparatus according to the invention;

FIG. 2 is a representation of USER EXPERIENCE of Comparative online testing procedure

FIG. 3 is a representation of PROGRAM FLOW of Comparative online testing procedure

FIG. 4 is a representation of PROGRAM WORKING of Comparative online testing procedure

FIG. 5 is a representation and explanation of a Sample Report generated for a school

FIG. 6 is a representation of a sample report generated for an Administrative body like the Ministry of Education

FIG. 7 is a representation of a sample report generated for a student

FIG. 8 is a representation of a sample Macro Report Level 1 generated for a student

FIG. 9 is a representation of a sample Macro Report Level 2 generated for a student

FIG. 10 is a representation of a sample Macro Report Level 3 generated for a student

FIG. 11 is a representation of a sample Micro Report Level 1 generated for a student

FIG. 12 is a representation of a sample Micro Report Level 2 generated for a student

FIG. 13 is a representation of a sample Macro Report Level 1 generated for an Institution

FIG. 14 is a representation of a sample Macro Report Level 3 generated for an Institution

FIG. 15 is a representation of a sample Micro Report Level 1 generated for an Institution

FIG. 16 is a representation of a sample Macro Report Level 2 generated for an Institution

FIG. 17 is a representation of a sample Macro Report Level 1 generated for an Institution

FIG. 18 is a representation of a sample Macro Report Level 4 generated for an Institution

FIG. 19 is a representation of a sample Macro Report Level 1 generated for Controlling/Government body

FIG. 20 is a representation of a sample Macro Report Level 2 generated for an Institution

FIG. 21 is a flow chart representing the steps involved in implementing the invention.

FIG. 22 is a flow chart representing the steps involved generating an Individual's Comparative Performance Reports.

FIG. 23 is a flow chart representing the steps involved generating an Institution's Comparative Performance Reports.

FIG. 24 is a flow chart representing the steps involved generating a Controlling Body's Comparative Performance Reports.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is anticipated that the preferred embodiment of the present invention will be a commercial product sold under the trade name PowerTests™ to be used with the following operating systems and computer systems

Windows '95™, Windows '98™, Windows 2000™ or later versions

Windows NT™ or later versions

Operating systems being run on an Intel™. Pentium™. processor or later processors

Operating systems running on computer systems equivalent to Intel™ processors like those being manufactured by Cyrix, AMD and others or later processors

Operating systems like UNIX, LINUX, SOLARIS and equivalent operating systems brought out by other software developers and Hardware manufacturers

Other devices, software and operating systems brought about by various companies in the field of communications, entertainment, electronics and related areas.

And equivalent modifications to these particular operating systems and processors would be evident and not be beyond the present invention.

Accordingly, the trade name will be referred to throughout this detailed description as the entire software program, A method for generating customizable comparative online reports to continuously track the comparative performance of persons in a variety of subjects, that can also be customized as per the person's requirement. The context of the term PowerTests™ will make obvious the intended reference.

The computer is an apparatus for carrying out the preferred embodiment of the invention. A computer of the traditional type including ROM, RAM, a processor, etc. is operatively connected by wires to a display, keyboard, mouse and printer, though a variety of connections means and input and output devices may be substituted without departing from the invention. The processor operates to control the program within the computer, and receive and store data from the input devices and transmit data to the output devices. Notebook computers of similar configuration (ROM, RAM, processor, etc.), can be used as well. In addition, other devices that are being or may be connected to the Internet or World Wide Web like wireless devices including but not limited to mobile phones, pagers and similar communication devices, microwave ovens, washing machines, refrigerators, Televisions, and other machines that may connect to the Internet and World Wide Web.

Upon initiating the program, which may take place in a variety of conventional ways and is not part of the present invention, the computing device causes a facility to be displayed by means of which the person can select an online Test that she/he wishes to undertake, modify the testing process within a framework and answer the test questions. On completing the test, the person will have his comparative results available immediately. These results will compare the current performance of the person with his/her previous performances, with the performance of all or a subset of persons who have undertaken the test, will compare his/her performance with various groups of persons who have undertaken the tests, display his/her comparative results in a subject-wise (or equivalent) manner and a in variety of other forms not limited to the above description.

The comparative results also will be available for specific groupings of users. For example, the reports can be generated for a set of users grouped by School, location, sex or by age.

The following statements sum the spirit of comparative reports.

Comparative performance reports would be more valuable to a user than absolute performance reports, especially during training for a wide variety of competitive examinations.

Macro to micro level comparative reporting would give users valuable information on their performance.

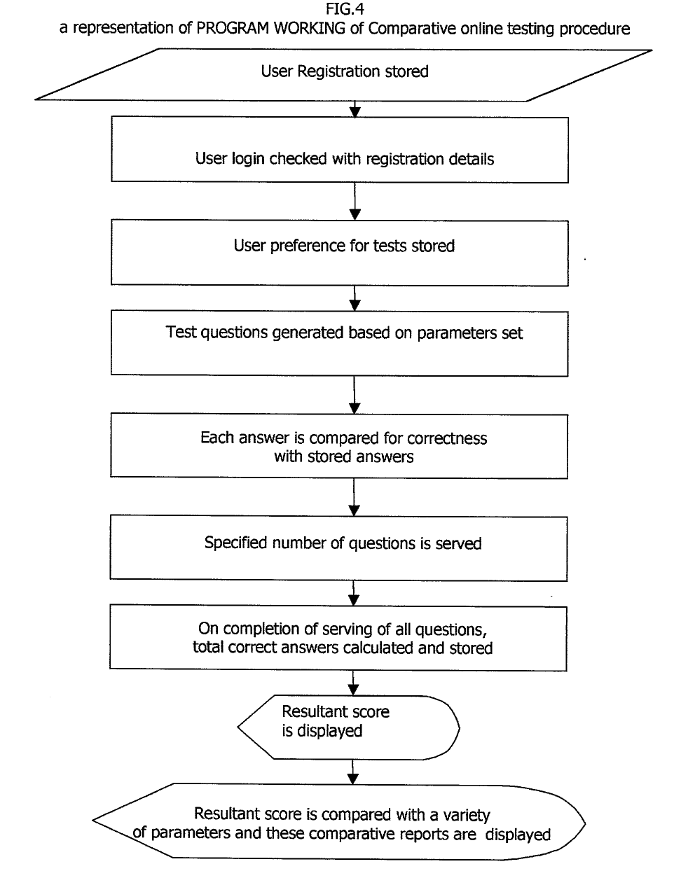

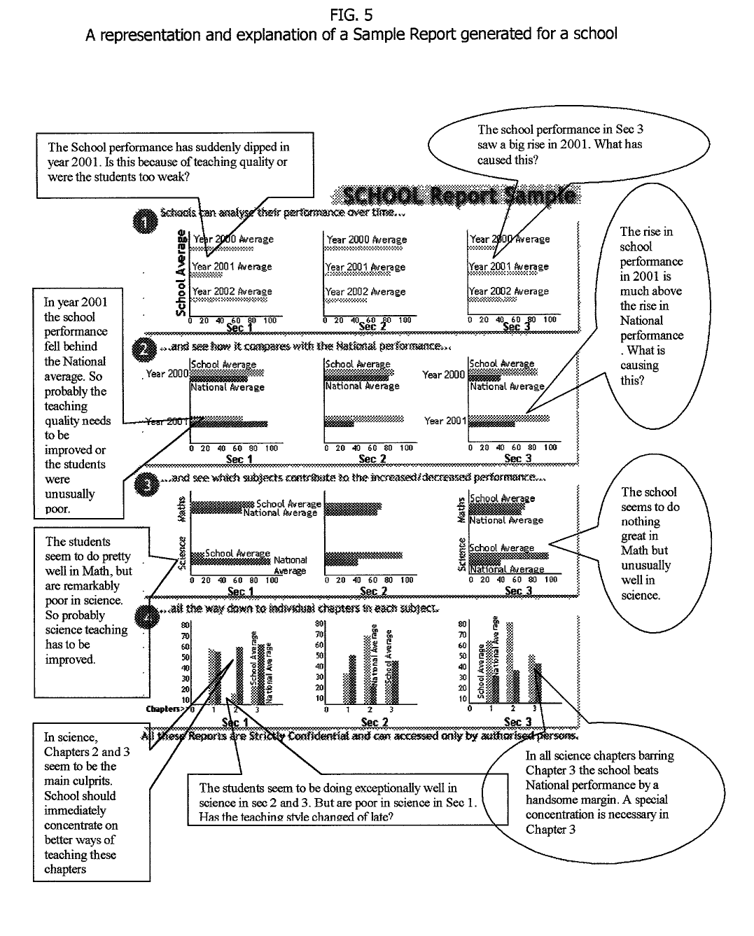

So all the reports generated would abide by the spirit of the above principles. As evidenced by the reports attached in the appendix (FIG. 4 to FIG. 6), it is now possible for the users to know precisely where they stand in relation to all other users who have taken the test. In case the individual performance increases/decreases, comparative online testing reports now make it possible to precisely know what causes the increase or decrease.

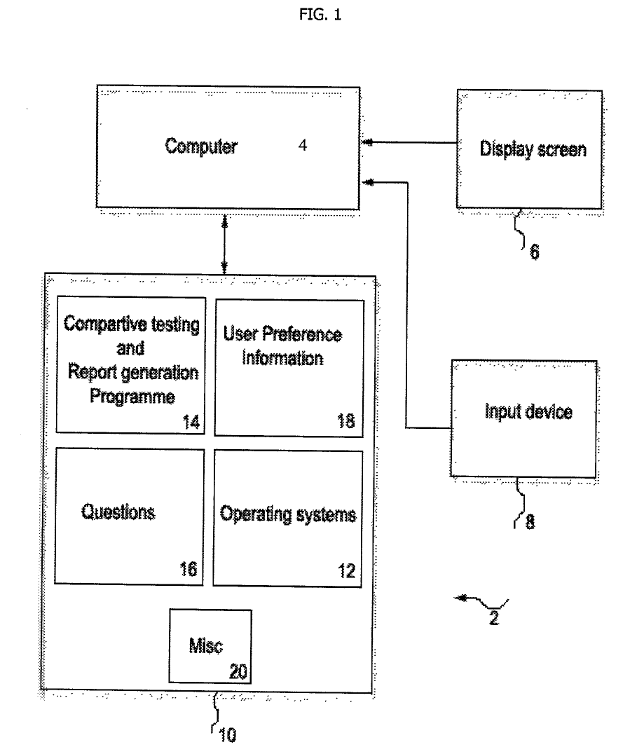

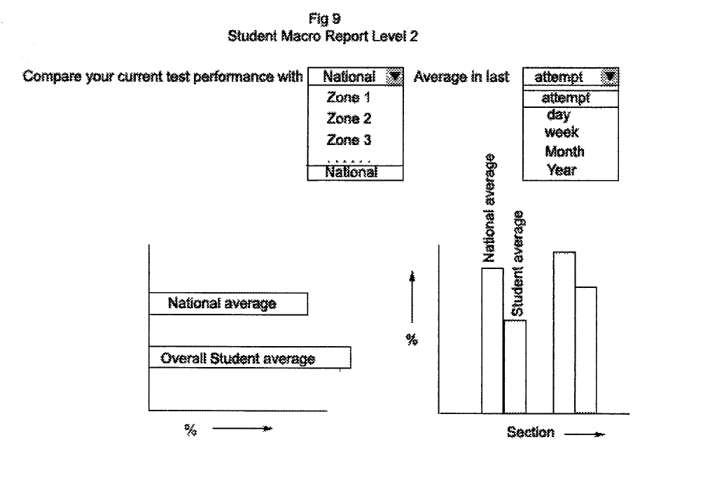

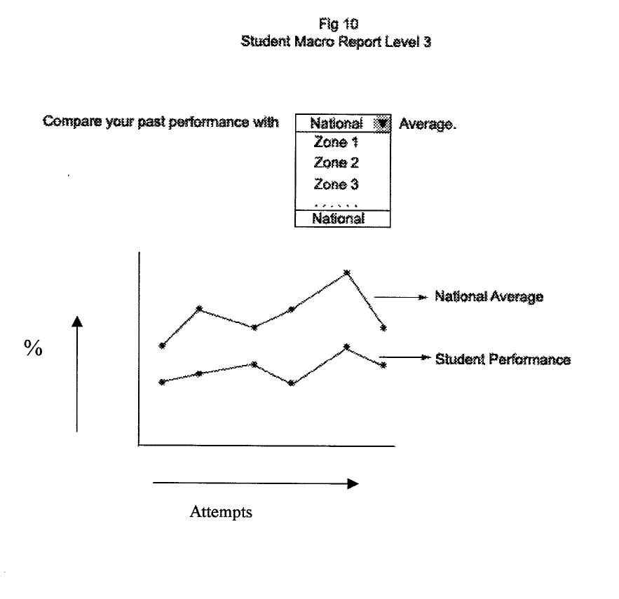

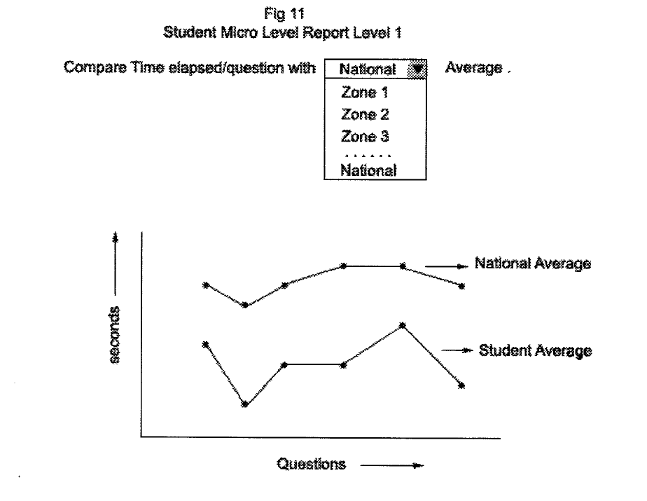

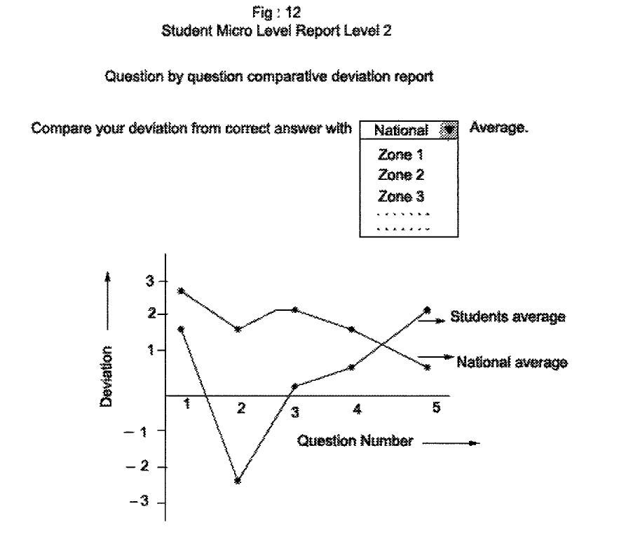

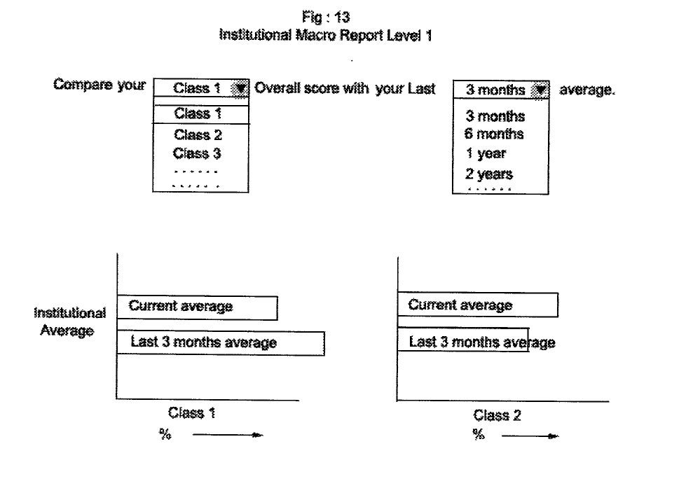

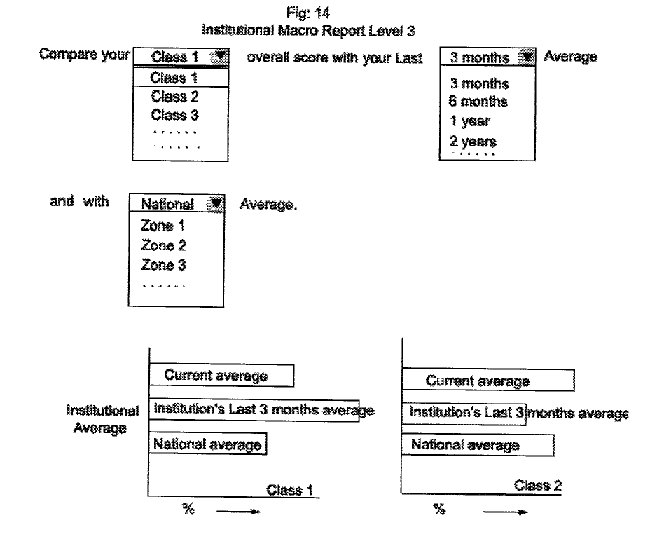

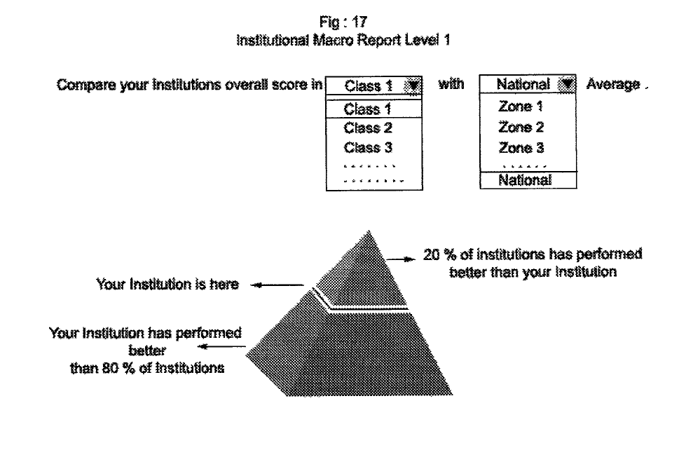

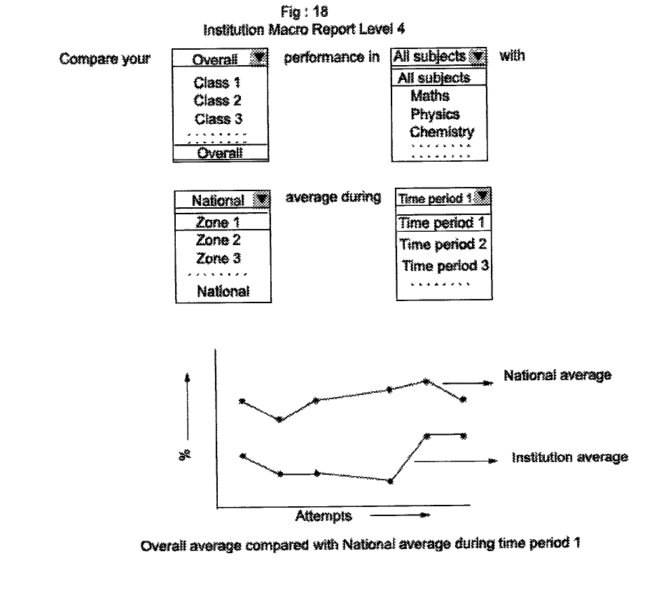

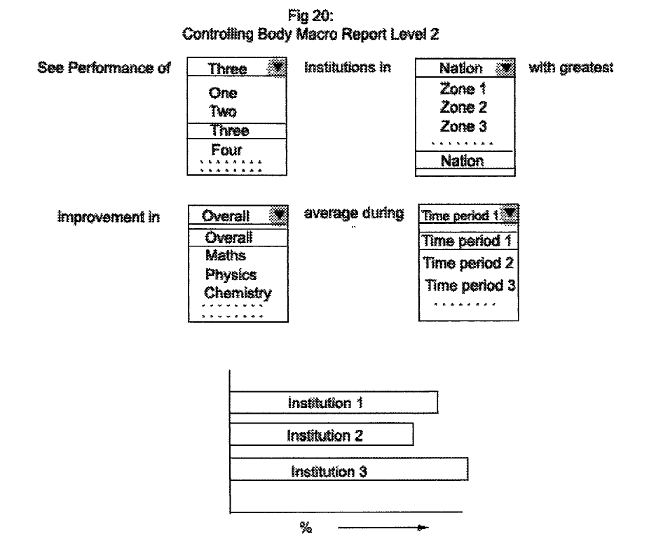

Embodiments of the invention are discussed below with reference to FIGS. 1-20. However, those skilled in the art will readily appreciate that the detailed description given herein with respect to these figures is for explanatory purposes as the invention extends beyond these limited embodiments.

FIG. 1 is a block diagram of an embodiment of an apparatus according to the invention. The apparatus 2 includes a computer 4, a display screen 6, an input device 8, and a memory 10. The memory 10 provides storage for an operating system 12, a comparative online testing and report generation program 14, practice questions 16, user's preference information 18, and miscellaneous information 20.

The computer 4 is preferably a microcomputer, such as a desktop or notebook computer. However, the computer 4 could also be a larger computer such as a workstation or mainframe computer. The computer 4 could also be remotely located from the user who would interact with the computer over a network.

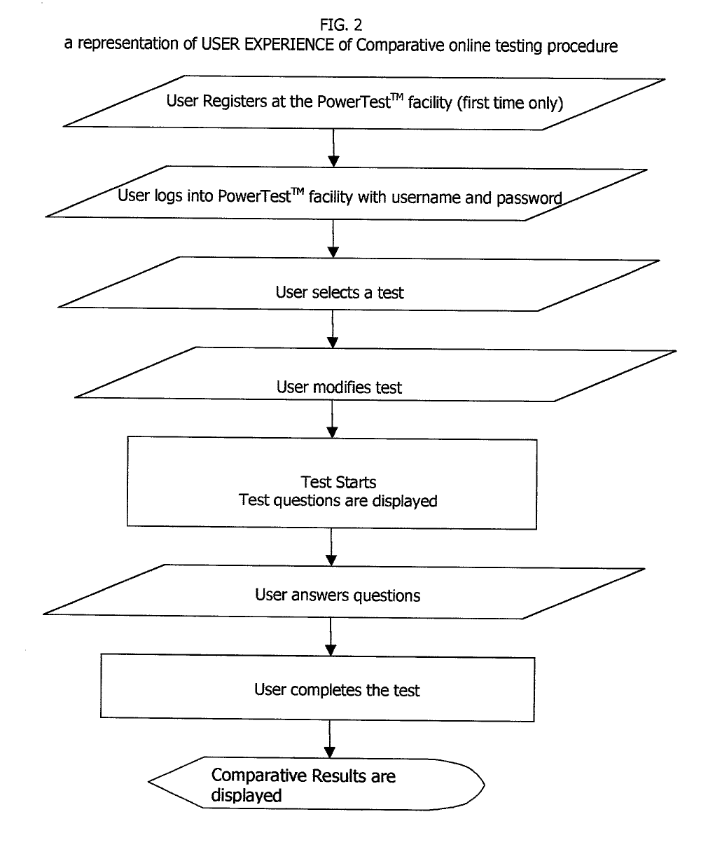

The memory 10 is connected to the computer 4. The memory 10 can consist of one or more of various types of data storage devices, including semiconductor, diskette and tape. In any case, the memory 10 stores information in one or more of the various types of data storage devices. The computer 4 of the apparatus 2 implements the invention by executing the comparative online testing and report generation program 14. While executing comparative online testing and report generation program 14, the computer 4 retrieves the practice questions 16 from the memory 10 and displays them to the user on the display screen 6. The user then uses the input device 8 to select an answer choice for the question being displayed. When the computer 4 executes the comparative online testing and report generation program 14, a comparative online testing and report generation method according to the invention is carried out. The details of various methods associated with the Comparative Online Testing and report generation program 14 are described in detail below in FIGS. 2-20.

The comparative online testing and report generation program 14, according to the invention will cause preference information 18 and miscellaneous information 20 to be produced. The preference information 18 may, for example, include the type of test or the section chosen, the amount of ‘deviation’ of each answer choice from the correct answer etc., the performance information 18 may also include a subject and a topic for each question. The miscellaneous information 20 can include any additional data storage as needed by the computer 4, e.g., various flags and other values that indicate options selected by the user or indicate user's state of progress. The user's performance information 18 and miscellaneous information 20 are stored to, or retrieved, from the memory 10 as needed by the computer 4. The operating system 12 is used by the computer 4 to control basic computer operations. Examples of operating systems include Windows, DOS, OS/2 UNIX, LINUX etc.

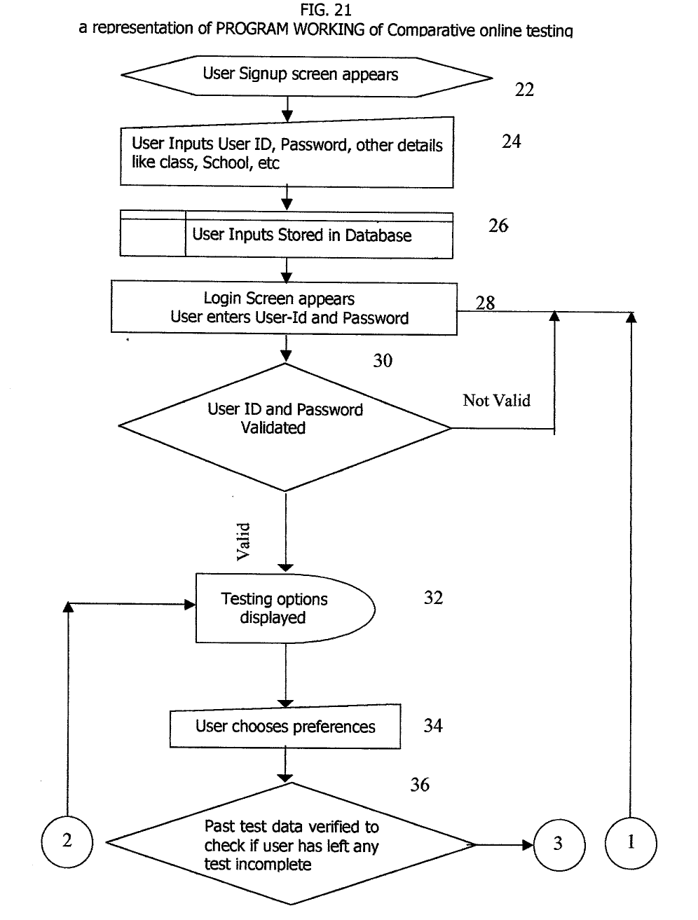

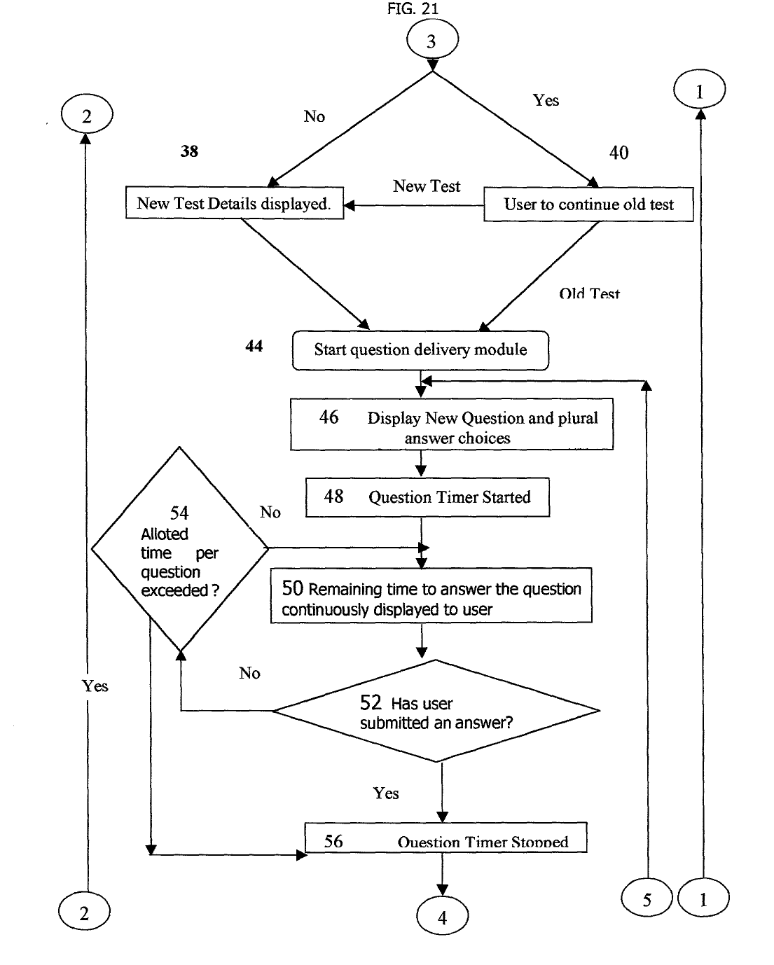

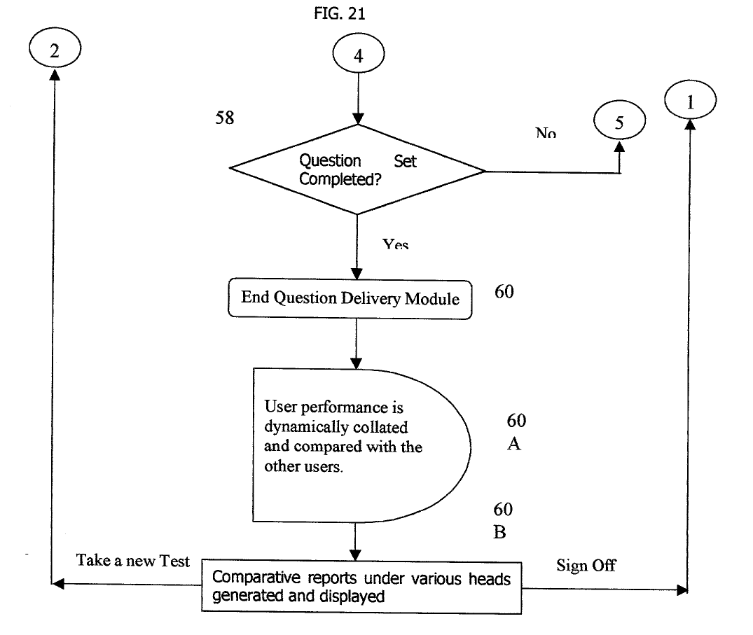

FIG. 21 is a block diagram of a first embodiment of comparative online testing and report generation method 14, according to the invention. The comparative online testing and report generation method begins by allowing the user to sign up 22 and collects user details 24. These details are permanently stored 26 and once the user details are stored, the user can log in using a unique log in ID and password 28. The user ID and password is validated 30 and various options regarding the test are displayed 32. The user is allowed to choose among the set of options provided 34. A check is conducted to ascertain if the user has left any past test incomplete 36. If so, the user is given a choice of continuing with the earlier test 40, or to take a new test 38.

Now the testing process starts by displaying 46 a question and a plurality of answer choices to a user. For example, the question and its answer choices can be retrieved from the various practice questions 16 stored in the memory 10 and then displayed on the display screen 6. Preferably, the question and its answer choices are very similar to the questions and answers, which actually appear on the competitive exam that the user is preparing for. It is also preferable that the questions and answers be displayed in a format and font that is very close to those used in the exam the student is preparing for. The closer the appearance and the format of the question and its answer to that of the actual exam, the more comfortable the user will be on the actual exam.

Once the question and its answer choices are displayed 46, a question timer is started 48. The question timer operates to keep track of the amount of time elapsed from the time the question was displayed until the time the user selects an answer choice. As most multiple-choice competitive exams are time-limited, keeping track of the users time performance for each question is very important. As the question timer monitors the elapsed time, a visual indication of the elapsed time is displayed 50 through a digital stopwatch or some other suitable technique is used on the display screen 6 to provide a visual indication of the elapsed time to the user. By displaying 50 a visual indication of the elapsed time, the user becomes sensitized to the amount of time he/she spends to answer questions and how he/she is doing time-wise with respect to a predetermined duration of time. Alternatively, an audio signal could also be used.

Next, a decision 52 is made based on whether the user has selected an answer choice for the question. If the user has not yet selected an answer choice, the program 14 awaits the user's selection while periodically updating the visual indication of the elapsed time being displayed 50.

A decision 54 is then made based on whether the allotted time for the question displayed is exceeded. If it is not, the question already loaded still remains visible to the user and the time elapsed gets displayed. But if the allotted time per question is exceeded, timer is stopped 56 and a decision 58 is made to check if the question set is completed. If the question set is not completed, the program displays the next question from the question set and starts the process all over again. If the question set has been completed, question delivery module ends 60. Once the user has submitted an answer choice for the question, the question timer is stopped 56. The question timer is stopped at this time so that only the time for the user to submit his/her first answer choice is

Next, a decision 58 is made based on whether a question set is complete. Although not previously mentioned, the questions are preferably presented to the user in sets of questions. Preferably, a set could include about thirty questions. The user is required to work through at least one entire question set in a single sitting. This forces the user to concentrate on the questions and the problem-solving approach for a reasonable period of time (typically 30-60 minutes), even if the user works through a single set. In this regard, if the question set is not yet complete, the program 14 will reset the question timer and return to the start of the question delivery module 46 to display the next question of the question set. On the other hand, once the question set is complete, the delivery of questions closes for the given question set.

After the question set is completed, the stored answers of the user are collated 60 A and compared with the answers of other users who have taken the test. A variety of comparative reports 60 B are then displayed to the user

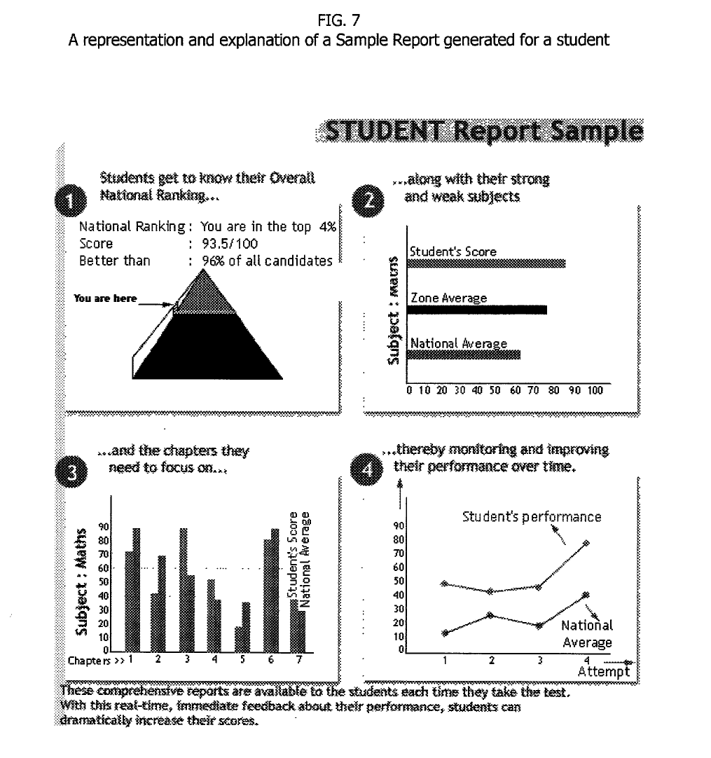

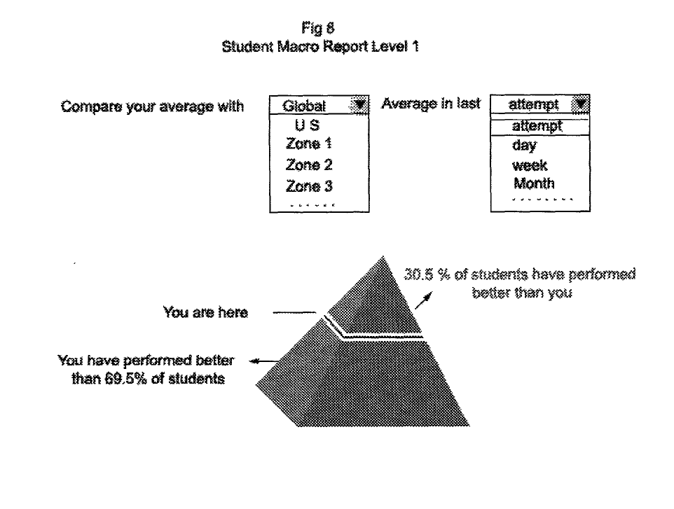

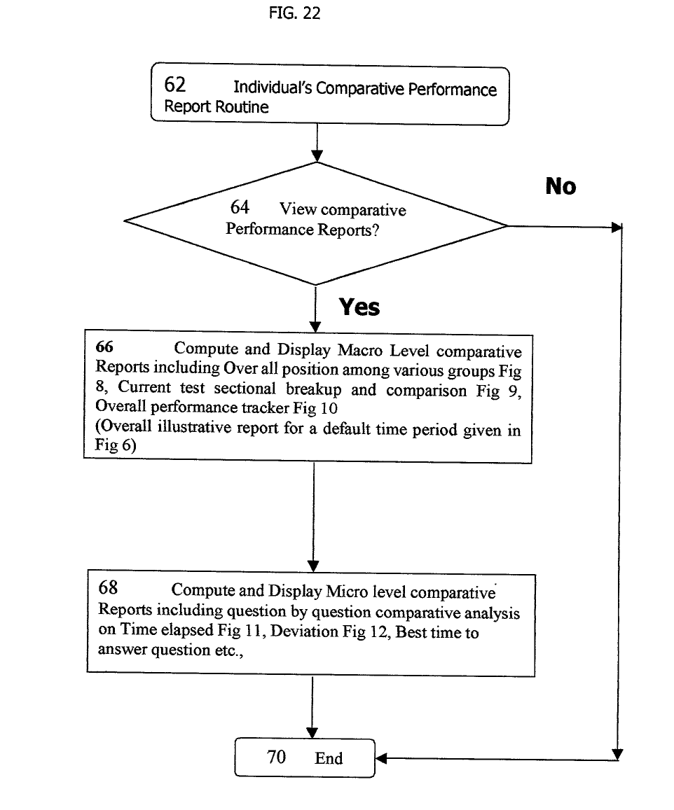

FIG. 22 is a block diagram of an individual's comparative Performance Report routine according to the invention. As the user works through the question delivery module, performance information is routinely saved by the computer 4 to the memory 10. At the end of a question set, Individual's comparative Performance Report routine 62 would enable a user to view comparative performance information to enable the user to understand his/her performance in comparison with the performance of others who have taken the test. Specifically, the performance evaluation routine 62 begins by displaying 66 The Macro level reports as detailed in FIGS. 7, 8, 9, 10) All the macro level reports gives an overall indication of where exactly the user stands with respect to others who have taken the test

Next, the Micro level reports 68 are computed and displayed as detailed in FIGS. 11,12, The micro level reports break up the overall Macro level reports into various sub-categories and let the user put his finger precisely on where his comparative performance is good and where it needs to be improved.

The graphs of both Macro and micro level reports are displayed dynamically as soon as the user completes the test by comparing the users performance with the performance of other users under various categories. The FIGS. 7, 8, 9, 10, 11, 12 display in detail the graphs produced. Though an indicative display of graphs is given, the same data can be displayed using a wide variety of graphs like Bar Charts, Pie Charts etc., according to the user's preference.

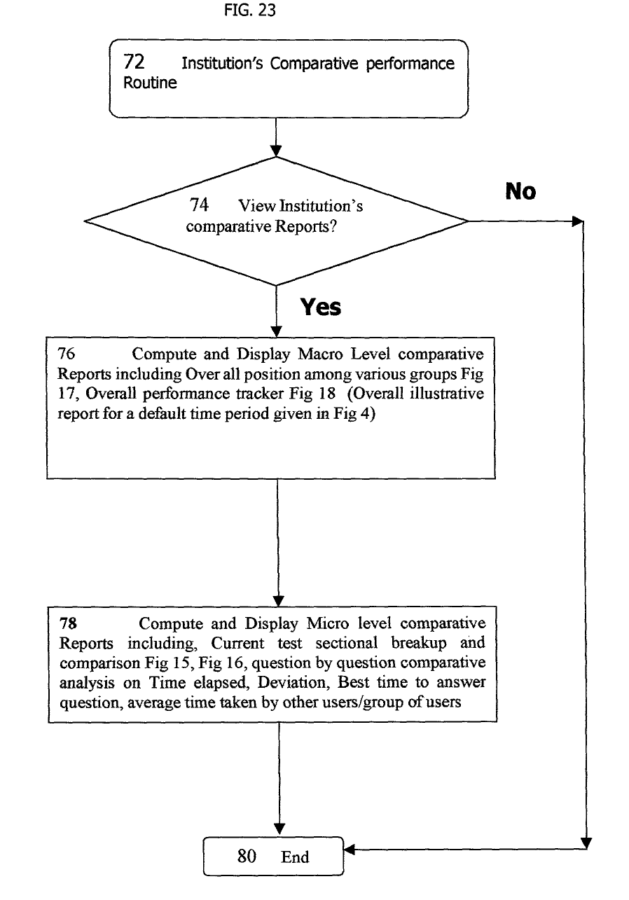

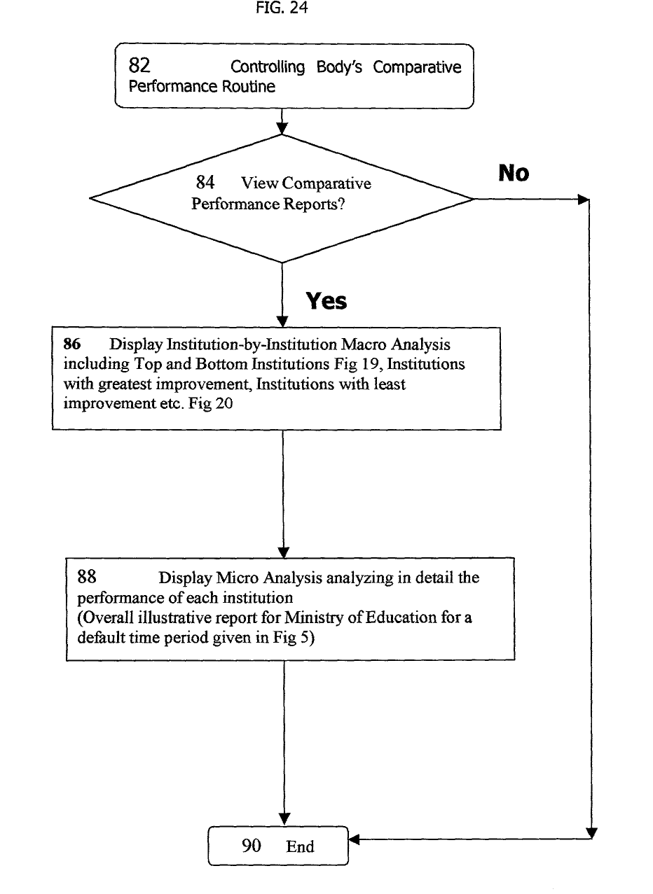

FIG. 23 is a block diagram of an institution's comparative Performance Report routine according to the invention. As the user works through the question delivery module, performance information is routinely saved by the computer 4 to the memory 10. At the end of a question set, comparative Performance Report routine 72 would enable an institution to aggregate individual user's results and view comparative performance information to understand the Institution's performance in comparison with the aggregate performance users from institutions who have taken the test. Specifically, the performance evaluation routine 72 begins by displaying 76 The Macro level reports as detailed in FIGS. 13,14,17) All the macro level reports gives an overall indication of where exactly the institution stands with respect to other institutions whose students have taken the test.

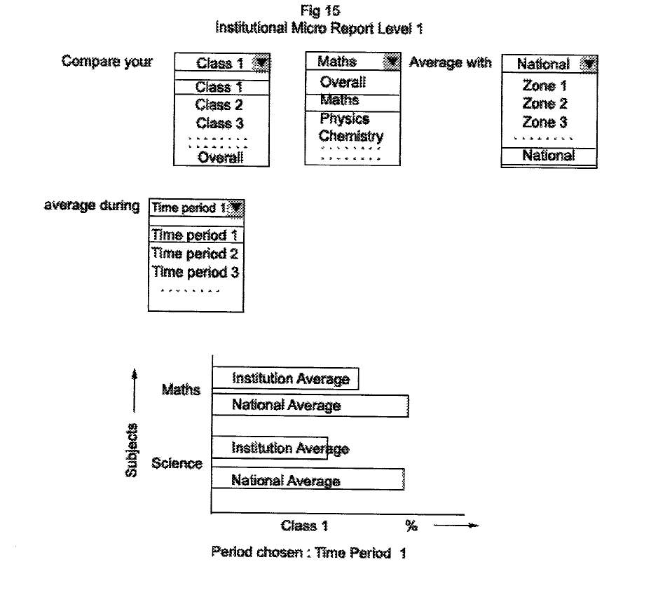

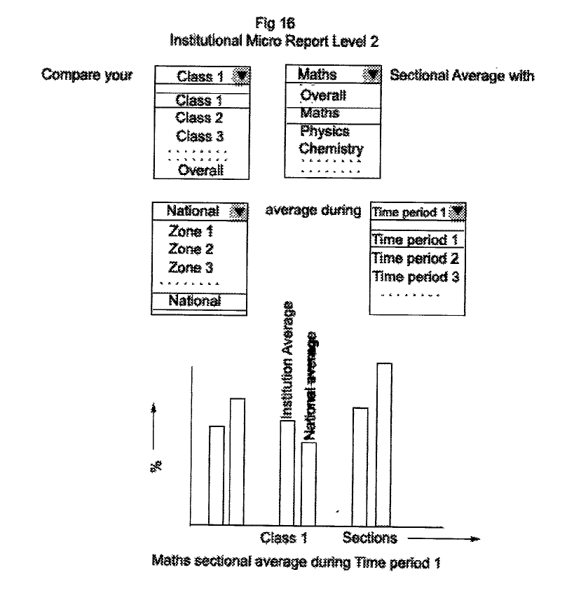

Next, the Micro level reports 78 are computed and displayed as detailed in FIGS. 15,16. The micro level reports break up the overall Macro level reports into various sub-categories and let the institution put its finger precisely on where its comparative performance is good and where it needs to be improved.

The graphs of both Macro and micro level reports can be displayed dynamically as soon as the user(s) from an institution complete the test. These reports are generated by comparing the aggregate performance of users from an institution with the aggregate performance of other users from other institutions under various categories. The FIGS. 13, 14, 15, 16, 17, 18 display in detail the graphs produced Though an indicative display of graphs is given, the same data can be displayed using a wide variety of graphs like Bar Charts, Pie Charts etc., according to the user's preference.

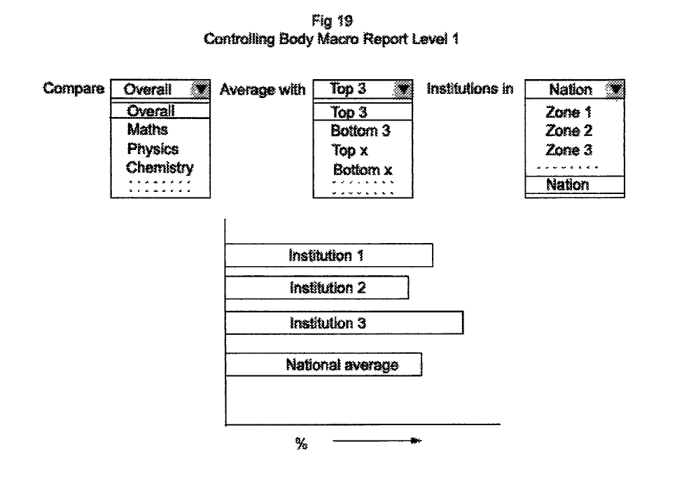

FIG. 23 is a block diagram of Report generation routine for a controlling body like the Ministry of Education whose focus would be to improve accountability and performance of its member institutions. As the user works through the question delivery module, performance information is routinely saved by the computer 4 to the memory 10. At the end of a question set, comparative Performance Report routine 82 would enable aggregation of various user's results and various institution's results. Specifically, the performance evaluation routine 82 begins by displaying 86 The Macro level reports as detailed in FIGS. 19,20) All the macro level reports gives an overall indication Institutions at the top and bottom of the pyramid.

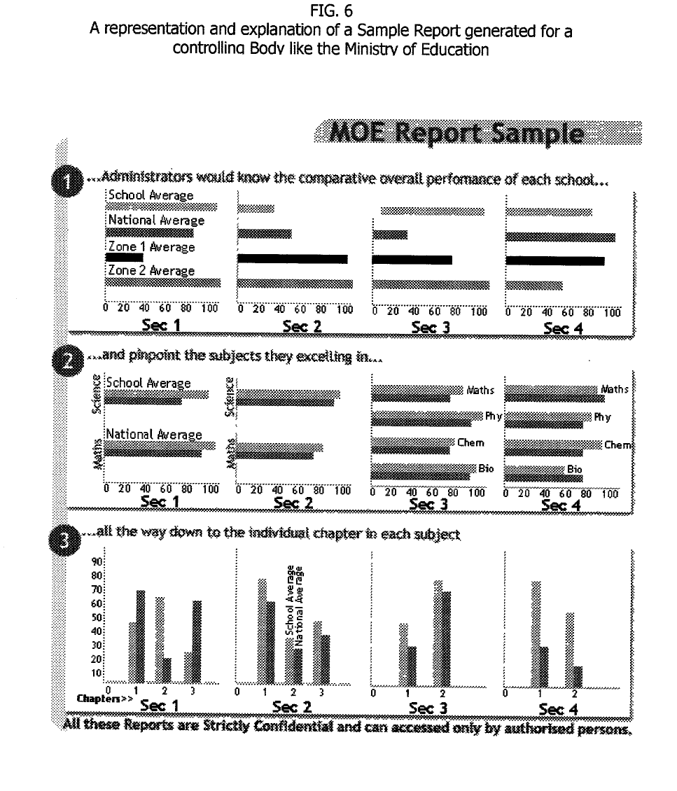

Next, the Micro level reports 88 are computed and displayed as detailed in FIG. 6. The micro level reports break up the overall Macro level reports into various sub-categories and let the controlling body pinpoint where exactly an Institution's comparative performance is good and where exactly it needs to be improved.

The graphs of both Macro and micro level reports can be displayed dynamically as soon as the user(s) from an institution complete the test. These reports are generated by comparing the aggregate performance of users from an institution with the aggregate performance of other users from other institutions under various categories. The FIGS. 6 19,20 display in detail the graphs produced. Though an indicative display of graphs is given, the same data can be displayed using a wide variety of graphs like Bar Charts, Pie Charts etc., according to the user's preference.

FIG. 2 details the user experience in using the invention. The figure being self explanatory, elaborate explanation is omitted.

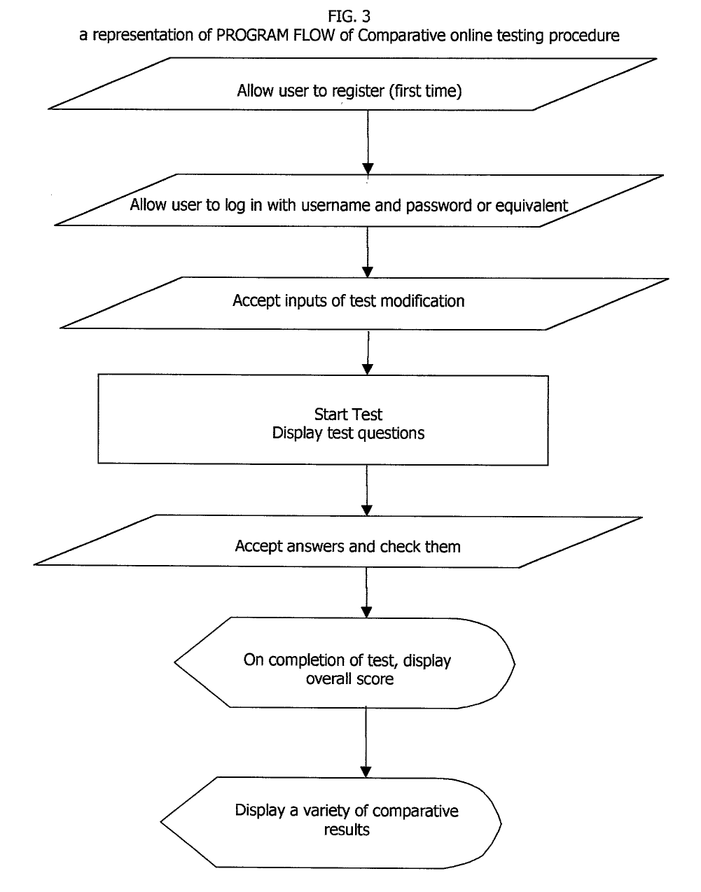

FIG. 3 details the program flow of the invention. The figure being self explanatory, elaborate explanation is omitted.

FIG. 4 details the steps in the program working. The figure being self explanatory, elaborate explanation is omitted.

Although not shown in the above block diagrams (but illustrated in the accompanying figures), the comparison need not be limited to a particular time frame. In many cases comparing performances over a large time period can help draw meaningful conclusions. For convenience sake the figures have been labeled as Macro level and Micro Level reports. Though, this classification needs to be done by the actual user, Macro level reports are generated to give an overview about larger trends whereas Micro Level reports try to uncover the smallest details.

Though a variety of reports have been reproduced, the list is just indicative and by no means exhaustive. A person skilled in the art can use the basic principles of Comparative Report generation to generate an infinite variety of reports as per the need. Hence the invention is not limited by the reports reproduced here and all varieties of comparative reports built upon the basic principles outlined above would fall within the scope of the invention.

The above-described embodiments of the method can also be combined to yield numerous combinations.

The many features and advantages of the invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

We claim:

1. A method of generating Customizable Comparative Online Testing reports comprising the steps of:
Delivering a set of questions to the user over a network based on various criteria.
Storing responses of the user to each question.
Calculating and displaying the comparative performance of each user, in relation to a set or subset of other users who have taken the test.
Collating the performances of individual users or groups of users under various criteria and using it for displaying a variety of comparative reports.

2. The method of claim 1, further comprising the step of customizing the set of questions delivered to each user, based on various criteria.

3. The method of claim 1, further comprising the step of the user being able to select certain options for modifying the testing procedure within a framework to suit his requirement.

4. A method as claimed in claim 1, that can operate independently or as part of a network of devices or part of any kind of computing or processing device.

5. The method of claim 1, further comprising the step of grouping the responses of the users under various criteria like age, state, school, sex etc.,

6. The method of claim 5, further comprising the step of the grouped data used for generating a variety of comparative reports.

7. A data processing system for generating customizable comparative online Testing reports comprising:
circuitry operable for delivering a set of questions to the user over a network;
circuitry operable for storing the user responses to the questions so delivered; and
circuitry operable for collating the stored responses of various users; and
circuitry operable for generating a variety of comparative reports based on the stored and collated responses.

8. The method of claim 1, further comprising the following implementation procedure:
accepting user responses to a set of questions;
storing the user responses
Collating the responses of various users under various criteria
Generating a variety of comparative reports based on the stored and collated information.

9. The method of claim 1, further comprising a program product adaptable for storage on program storage media, the program product operable for generating customizable comparative Online Testing reports comprising:
programming for delivering a set of questions to the user based on numerous criteria
programming for storing responses of the user to the said questions
programming for collating various user responses and
programming for generating a variety of comparative reports based on the collated responses.

10. A computer readable medium containing computer instructions for generating customizable comparative Online Testing reports said computer readable medium comprising:
computer program code, executable by a computer, for causing a question and a plurality of answer choices to be displayed;
computer program code, executable by a computer or any other computing device, for causing a per-question time duration to be displayed, the per-question time duration being associated with an amount of time a user spends answering the question after the question and the answer choices are displayed;
computer program code, executable by a computer, for receiving the user's selection of one of the answer choices;
computer program code, executable by a computer, for displaying, at a user's request, a variety of comparative reports containing detailed information of where exactly the user stands relative to all other users who have taken the tests
Computer program code, executable by a computer, for displaying, at a user's request, a variety of comparative reports containing detailed information of where groups of users (grouped under various criteria like School, geography, age, sex etc.,) stand relative to all other users who have taken the tests
